(19) United States
(12) Patent Application Publication
(10) Pub. No.: US 2008/0159180 A1
(43) Pub. Date: Jul. 3, 2008

(54) SYSTEM AND METHOD FOR A HIGH RELIABILITY BASE LAYER TRUNK

(76) Inventors: Reha Civanlar, Palo Alto, CA (US); Alexandros Eleftheriadis, Tenafly, NJ (US); Ofer Shapiro, Fair Lawn, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/015,937

(22) Filed: Jan. 17, 2008

Related U.S. Application Data
(63) Continuation of application No. PCT/US2006/028367, filed on Jul. 20, 2006.
(60) Provisional application No. 60/701,111, filed on Jul. 20, 2005.
(60) Provisional application No. 60/714,600, filed on Sep. 7, 2005.
(60) Provisional application No. 60/723,347, filed on Oct. 4, 2005.

(51) Int. Cl. H04L 12/18

(52) U.S. Cl. 370/261

(57) ABSTRACT

A method for transport of high-priority, loss-sensitive data and other less loss-sensitive data between parties in a conference or communication session on an electronic communications network includes establishing a high-reliability connection between two points in the network using a connection technology or transport method that is different than that used for otherwise transmitting conference or communication session data between the two points and transmitting the high-priority, loss-sensitive data over the established high-reliability connection.

### CROSS-REFERENCE TO RELATED APPLICATIONS

This application claims the benefit of U.S. provisional patent application Ser. Nos. 60/701,111 filed Jul. 20, 2005, No. 60/714,600 filed Sep. 7, 2005, and 60/723,347 filed Oct. 4, 2005. Further, this application is related to co-filed U.S. patent application Ser. Nos. ______ [SVCSystem], ______ [SVC] and ______ [Jitter]. All of the aforementioned priority and related applications are hereby incorporated by reference in their entireties.

### FIELD OF THE INVENTION

The present invention relates to multimedia and telecommunications technology. In particular, the invention relates to systems and methods for audio and videoconferencing between endpoints over electronic communication networks based on signal compression using scalable video and audio coding techniques.

### BACKGROUND OF THE INVENTION

Scalable coding techniques allow data signals (e.g., audio and/or video data signals) to be coded and compressed for transmission in a multiple-layer format. The information content of a subject data signal is distributed among its coded multiple layers. Each of the multiple layers or combinations of the layers may be transmitted in respective bitstreams. A “base layer” bitstream, by design, may carry sufficient information for a desired minimum or basic quality level reconstruction, upon decoding, of the original audio and/or video signal. Other “enhancement layer” bitstreams may carry additional information, which can be decoded to improve upon the basic level quality reconstruction or resolution of the original audio and/or video signal. The scalably coded multiple-layer structure is such that the decoding a particular enhancement layer bitstream requires the availability of the information in the base layer bitstream and possibly the additional information in other lower enhancement layer bitstreams.

It should be noted that other methods of creating enhancement layers also include: a) complete representation of the high quality signal, without reference to the base layer information, a method also known as ‘simulcasting’; or b) two or more representations of the same signal in similar quality but with minimal correlation, where a sub-set of the representations on its own would be considered ‘base layer’ and the remaining representations would be considered an enhancement. This latter method is also known as ‘multiple description coding’. For brevity all these methods are referred to herein as base and enhancement layer coding.

Scalable Audio Coding (SAC) and Scalable Video Coding (SVC) may be used in audio and/or videoconferencing systems implemented over electronic communication networks. Co-filed U.S. patent application Ser. Nos. ______ [SVCSystem] and, ______ [SVC] describe systems and methods for scalable audio and video coding for exemplary audio and/or videoconferencing applications. The referenced patent applications describe particular IP multipoint control units (MCUs) called Scalable Video Conferencing Servers (SVCS) and Scalable Audio Conferencing Servers (SACS) that are designed for coordinating the transmission of SAC and SVC layer bitstreams between conferencing endpoints.

For the conferencing applications, in which audio and video pictures are exchanged between conferencing endpoints, the loss of enhancement layer information or bitstreams during transmission may be tolerable. However, any loss of base layer information or bitstreams during transmission may be intolerable. Loss of data or information in the base layer bitstreams can lead to significant degradation of the desired basic or minimum quality of audio and/or video signals reconstructed at receiving endpoints. Such degradation of the desired basic or minimum quality reconstructions may result in unsatisfactory performance of the conferencing applications. Thus, the near-lossless delivery of the base layer bitstreams over the communications network is important for any application based on scalable or layered codecs.

On best-effort networks (e.g. Internet Protocol (IP) networks), delivery of the base layer bitstreams may occur over unreliable channels, in which reliable delivery may be implemented using available transport-layer techniques. Transport-layer techniques available for this purpose include, for example, standard techniques (e.g., forward error correction (FEC) and automatic repeat request (ARQ)), and the techniques described in U.S. Pat. No. 5,481,312, entitled “Method Of And Apparatus For The Transmission Of High And Low Priority Segments Of A Video Bitstream Over Packet Networks,” which may be used to improve recovery mechanisms for lost packet transmissions and to mitigate the effects of packet loss. In some instances, the base layer may be transmitted reliably off-line prior to real-time data transmission as described in U.S. Pat. No. 5,510,844, entitled “Video Bitstream Regeneration Using Previously Agreed To High Priority Segments.”

On Internet Protocol (IP) networks that allow differentiated services (DiffServ), the base layer can be transmitted over a high reliability connection. However, in practice, allocating a high reliability channel for the base layer data transmission to each endpoint or conference bridge connection in the network can be difficult, for example, when there are a number of different conferencing sessions of short duration. Reserving and provisioning a high reliability channel over a Diffserv-capable IP network or other network, involves additional signaling and/or manual configuration procedures. These additional signaling and/or manual configuration procedures can be burdensome, especially when they have to be repeated for the number of different conferencing sessions of short duration, which may require different sets of high reliability channel connections between conferencing endpoints and/or bridging servers (e.g., MCUs, SVCSs and SAC's).

Consideration is now being given to alternate or improved ways for establishing high reliability network communication channels to transport sensitive base layer bitstreams between conferencing endpoints.

### SUMMARY OF THE INVENTION

Systems and methods are provided for establishing permanent or semi-permanent high reliability channels (HRC) between endpoints and bridges in an electronic communications network. A HRC bandwidth may be reserved for and used for reliable transport and delivery of high-priority or sensitive data (e.g., base layer data bitstreams in conferencing applications that employ scalable audio and/or video coding of data signals).

The inventive systems and methods involve establishing a high-reliability connection with reserved bandwidth for transmitting real-time data from a first endpoint or server to a second endpoint or server in an electronic communications network. In an embodiment of the present invention, the high-reliability connection is based on a technology that is different than the one used for conventional transmission of data between the first endpoint/server and the second endpoint/server in the electronic communications network. Accordingly, the high-reliability connection can be advantageously established between the endpoints/servers independently of the individual communication or conferencing sessions hosted on the network.

In another exemplary embodiment of the present invention, high-priority and sensitive data from two or more servers or endpoints is multiplexed into a single packet for transmission over a connection in a manner designed to ensure reliable transmission and delivery of the data. The connection may be a permanent connection, or a semi-permanent connection that is set up or terminated separately from the conferencing session, or a semi-permanent connection where the bandwidth is adjusted in operation in response to estimates of network traffic between the first server and the second server.

### BRIEF DESCRIPTION OF THE DRAWINGS

FIGS. 1A and 1B are block diagrams illustrating features of an exemplary system for establishing high reliability connections for delivering sensitive data in a protective manner, in accordance with the principles of the present invention.

Throughout the figures the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION OF THE INVENTION

The present invention provides a permanent or semi-permanent high reliability connection (HRC) between network points for transmission and delivery of high-priority or sensitive data. The high-priority or sensitive data may, for example, be scalably coded base layer data used in point-to-point or multipoint conferencing applications, which employ scalable audio and/or video coding. It should be noted that other methods of creating a base layer also include simulcasting and multiple description coding, among others, and. for brevity we refer to herein all these methods as base and enhancement layer coding.

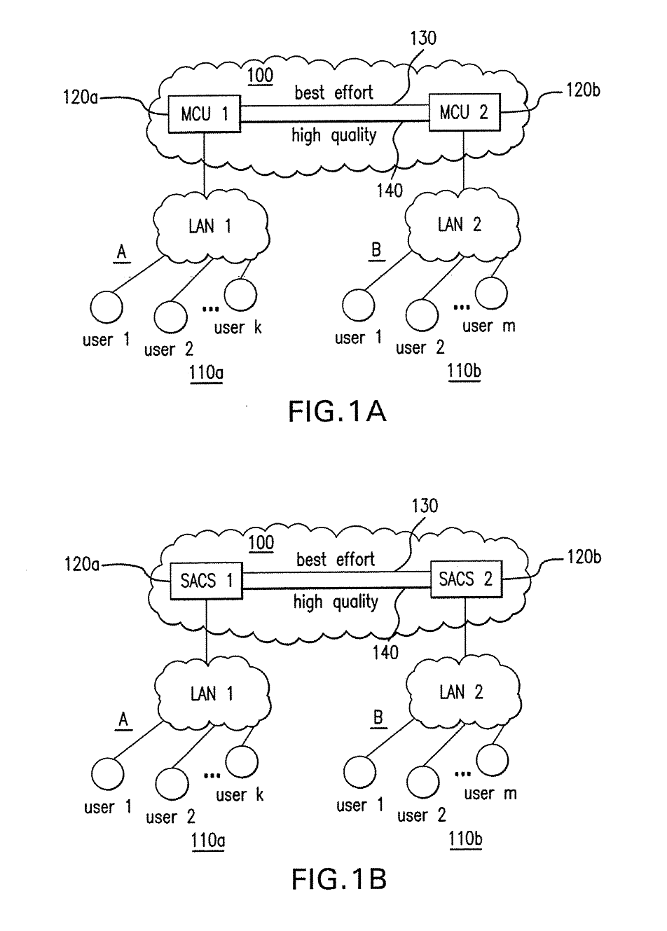

FIGS. 1A and 1B show implementation of an HRC 140 in an exemplary electronic communications network (e.g., IP network 100). Exemplary communications network 100 may, for example, span two remote college campuses A and B each of which is served by a local area network that provide services to local users (e.g., LAN 1 and LAN 2 operating in college campuses A and B for local users 110a and 110b, respectively). MCU 120a and MCU 120b are disposed in LAN 1 and LAN 2, respectively. Local users 120a (e.g., users 1, 2, . . . k) and 120b (e.g., users 1, 2, . . . m) at each campus may be connected to their respective MCU units in any suitable network topology (e.g., a star configuration). Further, MCU 120a and 120b may have any suitable network bridge device design, including, for example, conventional MCU, scaleable video coding server (SVCS), and scaleable audio coding server (SACS) designs. Exemplary SVCS and SACS are described in co-filed U.S. patent application No. SVCS. FIG. 1B shows an example where MCU 120a and 120b are SACS devices.

For inter-campus communications over communications network 100, MCU 120a and MCU 120b may be connected by a best-effort link or trunk 130.

In accordance with the present invention, MCU 120a and MCU 120b also are connected to each other by a second communication link or trunk (i.e., HRC 140) in parallel to best-effort trunk 130. HRC 140 may be permanently established between the two MCUs to provide a minimum of reliable services for audioconferencing, videoconferencing and other delay-sensitive applications. HRC 140 may, for example, be designated to carry loss-sensitive base layer bitstreams between the two MCUs for inter-campus scalable video/audio conferencing applications. Less loss-sensitive bitstreams (e.g., enhancement layers bitstreams) may be transported over best-effort trunk 130 using conventional IP network techniques.

HRC 140 may be implemented or configured using a technology other than the conventional best-effort delivery technology used in IP network 100 to establish best-effort trunk 130. For example, using conventional best-effort delivery technology, a shared line in IP network 100 may function as best-effort trunk 130 for delivering enhancement layers data. In contrast, HRC 140 may be a private line with bandwidth reserved or designated for transporting base layer data.

HRC 140 may be a permanent trunk installation. However, in an alternate embodiment of the invention, in suitable IP networks HRC 140 may be configured as almost permanent or semi-permanent installation. For example, IP network 100 may be a network having differentiated services (DiffServ) capabilities. In such a network, the DiffServ capabilities may be advantageously exploited to establish or designate a high reliability connection as HRC 140 for a predetermined fixed period of time. The bandwidth of the high reliability connection used as HRC may be adjusted and reserved for a fixed or variable period of time depending on network conditions.

In the absence of other methods for establishing HRC 140 or if an established HRC 140 is not sufficiently reliable, automatic repeat request (ARQ) or forward error correction techniques (FEC) may be used. For example, an endpoint (e.g., users 1, 2, etc.) or its bridge (e.g., MCU 120a or MCU 120b) may proactively repeat or duplicate transmissions of information delivered over HRC 140. The number of such automatic repeat transmissions may depend on forecasted channel error or loss conditions and may be suitably selected to prospectively compensate for expected losses in transmission. Alternatively, an endpoint or MCU may retransmit compensating information retrospectively in response to actual loss. For example, the endpoint of MCU may cache information transmitted over HRC 140, and retransmit specific cached information only upon request by a receiving endpoint or MCU. This procedure may be appropriate in cases where information loss can be detected and reported quickly by a receiving endpoint or MCU.

The aforementioned methods for establishing a reserved-bandwidth HRC 140 may be applied in an electronic communication network to endpoint-to-MCU, MCU-to-endpoint, or MCU-to-MCU connections, individually or in any suitable combination, depending on available channel characteristics and network conditions. Further, as previously noted, the MCUs may be of conventional design or may be designed for scaleable video and/or audio coded transmissions.

An important benefit of using a trunk with an HRC is that in a multi-hop connection, any protocol operations (e.g., retransmissions) related to reliability are limited between the two immediately connected points. This minimizes the impact to the end-to-end delay. In contrast, a system that operated on an end-to-end basis would have to sustain delays equal to the entire end-to-end delay.

Other aspects of the present invention relate to bandwidth management for HRC 140. In instances where there is excess bandwidth available on HRC 140, (i.e. when all of the reserved bandwidth of HRC 140 is not used for transporting the base layer bitstreams), one or more less loss-sensitive enhancement layers bitstreams also may be transported on HRC 140. Multiplexing the base layer bitstreams and allowed enhancement layers bitstreams over the high reliability channel may be accomplished using standard packet multiplexing technologies (e.g., TCP/IP stack technologies).

In another exemplary embodiment of the present invention, base layer video, audio and other time-sensitive data packets from several users may be combined or mixed into packets with larger payloads reducing the packet header overhead. The mixed-packet payloads have reduced bandwidth requirements and are transported over HRC 140 high-reliability connection.

Further, when scalable audio and/or video coding functions are used, there may be periodic changes in the data packet sizes in the audio video stream. In such circumstances, MCUs 120a and 120b (e.g., SVCS or SACS) may be configured to send control signals to transmitting endpoints to modulate or stagger data transmissions in order to avoid accumulation of larger packets from different endpoints for transmission over HRC 140 at the same time. Such a configuration may even out bandwidth demand surges and improve trunk utilization.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention. For example, the inventive HRC has been described herein as a second communication link or trunk between two MCUs in a multi-endpoint conferencing arrangement. However, it is readily understood that the inventive HRC can be advantageously implemented in other network configurations and between any two network elements (e.g., network endpoints or terminals, inter- and intra-network points, network bridge devices or servers). For example, an HRC or trunk may be established between two users for direct endpoint-endpoint communications by interposing a suitably configured MCU (e.g., MCU 120a or MCU 120b) between the users. As another example, a suitably configured MCU may be merged or integrated with an endpoint itself to provide an HRC/trunk starting at the endpoint itself.

It also will be understood that in accordance with the present invention, the HRCs be implemented using any suitable combination of hardware and software. The software (i.e., instructions) for implementing and operating the aforementioned HRCs can be provided on computer-readable media, which can include without limitation, firmware, memory, storage devices, microcontrollers, microprocessors, integrated circuits, ASICS, on-line downloadable media, and other available media.

We claim:

1. A method for transport of high-priority, loss-sensitive data and other less loss-sensitive data between parties in a conference or communication session on an electronic communications network, the method comprising:
independent of the conference or communication session, establishing a high-reliability connection between two points in the network using a connection technology or transport method that is different than that used for otherwise transmitting conference or communication session data between the two points; and
transmitting the high-priority, loss-sensitive data over the established high-reliability connection.

2. The method of claim 1 wherein the high-priority, loss-sensitive data is base layer data of scalably coded video and/or audio data signals, and wherein establishing a high-reliability connection comprises reserving its bandwidth for transporting base layer data.

3. The method of claim 1 wherein at least one of the two points multiplexes data packets received from a number of the parties and transmits the multiplexed data packets over the high-reliability connection.

4. The method of claim 1 wherein high-priority loss-sensitive data from at least two parties are multiplexed into a single packet under a common header for transmission over the high-reliability connection.

5. The method of claim 1 wherein establishing a high-reliability connection comprises establishing a permanent high-reliability connection between the two points in the network.

6. The method of claim 1 wherein the electronic communications network is an IP network having differentiated services capabilities, and wherein establishing a high-reliability connection comprises using the differentiated services capabilities to reserve a connection between the two points for a period of time for transmitting the high-priority, loss-sensitive data.

7. The method of claim 1 wherein establishing a high-reliability connection comprises using a separate physical connection between the two points for transmitting the high-priority, loss-sensitive data, wherein the separate physical connection is in addition to connections otherwise used in the network for transmitting data between the two points.

8. The method of claim 1 wherein the high-reliability connection is established by the two points using a transport-layer technique.

9. The method of claim 1 wherein the two points consist one of a network endpoint, an inter-network point, an intra-network point and any combination thereof.

10. The method of claim 1 wherein establishing a high-reliability connection comprises at least one of transmitting a data packet at least twice and adding FEC information.

11. The method of claim 1 wherein establishing a high-reliability connection comprises establishing a semi-permanent connection that is set up or terminated separately from the conferencing session.

12. The method of claim 1 wherein establishing a high-reliability connection further comprises adjusting the bandwidth of the high-reliability connection in response to estimates of data traffic between the two points.

13. The method of claim 1 wherein establishing a high-reliability connection further comprises to signaling to the transmitting parties instructions to stagger data transmissions in order to avoid accumulation of data at either of the two points for transmission over the high-reliability connection.

14. The method of claim 1 wherein establishing a high-reliability connection and transmitting the high-priority, loss-sensitive data over the established high-reliability connection, further comprises making unused bandwidth in the high-reliability connection available for transmission of other data.

15. A system for transport of high-priority, loss-sensitive data and other less loss-sensitive data between parties in a conference or communication session on an electronic communications network, the system comprising:
a high-reliability connection between two points in the network, which connection is established independently of the conference or session, using a connection technology or transport method that is different than that used for otherwise transmitting conference or communication session data in the network between the two points; and wherein the high-reliability connection is designated for transmitting the high-priority, loss-sensitive data between the two points.

16. The system of claim 15 wherein the high-priority, loss-sensitive data is base layer data of scalably coded video and/or audio data signals, and wherein the high-reliability connection bandwidth is reserved for transmitting the high-priority, loss-sensitive data between the two intermediate points.

17. The system of claim 15 wherein at least one of the two points is configured to multiplex data packets received from a number of the parties and to transmit the multiplexed data packets over the high-reliability connection.

18. The system of claim 15 wherein at least one of the two points is configured to multiplex high-priority loss-sensitive data packets received from at least two parties into a single packet under a common header for transmission over the high-reliability connection.

19. The system of claim 15 wherein the high-reliability connection is a permanent high-reliability connection between the two points in the network.

20. The system of claim 15 wherein the electronic communications network is an IP network having differentiated services capabilities, and wherein the high-reliability connection is established using the differentiated services capabilities to reserve a connection between the two points for a fixed period of time for transmitting the high-priority, loss-sensitive data.

21. The system of claim 15 wherein the high-reliability connection is a separate physical connection between the two points, which separate physical connection is in addition to connections otherwise used in the network for transmitting data between the two points.

22. The system of claim 15 wherein the high-reliability connection is a connection established by the two points using a transport-layer technique.

23. The system of claim 15 wherein the two points consist one of a network endpoint, an inter-network point, an intra-network point and any combination thereof.

24. The system of claim 15 wherein the high-reliability connection comprises a connection over which a data packet is transmitted at least twice.

25. The system of claim 15 wherein the high-reliability connection is a semi-permanent connection.

26. The system of claim 15 wherein the high-reliability connection is a connection whose bandwidth is adjustable in response to estimates of data traffic between the two points.

27. The system of claim 15 wherein the high-reliability connection is established by signaling instructions to stagger data transmissions in order to avoid accumulation at either of the two points of data for transmission over the high-reliability connection.

28. The system of claim 15, which is configured to make unused bandwidth in the high-reliability connection available for transmission of other data.

29. Computer readable media comprising a set of instructions to perform the steps recited in at least one of claims 1-14.
